(19) United States
(12) Patent Application Publication
(10) Pub. No.: US 2026/0177976 A1
(43) Pub. Date: Jun. 25, 2026

(54) METHOD AND OPTICAL SYSTEM FOR RECONSTRUCTING HOLOGRAPHIC IMAGE USING AMPLITUDE MASK

(71) Applicant: Electronics and Telecommunications Research Institute, Daejeon (KR)

(72) Inventor: Hyun Eui KIM, Cheongju-si (KR)

(73) Assignee: Electronics and Telecommunications Research Institute, Daejeon (KR)

(21) Appl. No.: 19/426,883

(22) Filed: Dec. 19, 2025

(30) Foreign Application Priority Data
Dec. 20, 2024 (KR) 10-2024-0192792
Dec. 10, 2025 (KR) 10-2025-0195416

(51) Int. Cl. G03H 1/22

(52) U.S. Cl. CPC G03H 1/2205; G03H 2223/12

(57) ABSTRACT

Disclosed are a method and optical system for reconstructing a holographic image using an amplitude mask. According to an embodiment of the disclosure, an optical system may include: a light source for emitting light, a spatial light modulator for controlling a phase or amplitude of the light, an amplitude mask for spatially controlling the amplitude of the light and diffracting the light to expand a range of output angles of the light and a reconstruction plane on which a holographic image reconstructed based on interference of the light is formed, wherein the amplitude mask includes a plurality of apertures arranged at arbitrary locations, and wherein the plurality of apertures are formed as open holes or formed by mirrors that reflect or diffract the light.

### CROSS-REFERENCES TO RELATED APPLICATIONS

This application claims the benefits of and priorities to Korean Patent Application Nos. 10-2024-0192792, filed on Dec. 20, 2024, and 10-2025-0195416, filed on Dec. 10, 2025, the entire disclosures of which are hereby incorporated herein by reference in their entirety.

### TECHNICAL FIELD

The present disclosure relates to a method and optical system for reconstructing a holographic image using an amplitude mask. More specifically, the present disclosure relates to a method and optical system for reconstructing a holographic image by implementing an amplitude mask in a spatial light modulator.

### BACKGROUND

The following description merely provides background information related to the present embodiment and does not constitute prior art.

An augmented reality (AR) display technology is a technology that naturally displays virtual objects or information overlaid on the real world, and is being used in various industries such as education and entertainment. This allows users to experience both the real and virtual worlds simultaneously. An augmented reality display system uses a stereoscopy technique to provide users with a three-dimensional experience. The stereoscopy technique provides images with different parallaxes to the left and right eyes of a user, allowing the user's brain to perceive the images as three-dimensional. However, when the stereoscopy technique is used, an accommodation-vergence conflict problem may occur. That is, in the stereoscopy technique, the accommodation-vergence conflict occurs because the focus cannot be adjusted, which may cause dizziness, fatigue, or decreased three-dimensional perception in the user.

To address these issues, a holographic display technology has recently been utilized. The holographic display technology precisely reconstructs the wavefront of a 3D object using light diffraction and interference. The holographic technology allows a plurality of users to simultaneously view the same 3D image from various angles. A holographic display system visualizes a voxel in 3D space using a spatial light modulator (SLM). The 2D holographic pattern displayed on the spatial light modulator is generated by mathematically calculating a wavefront formed as the wavefront travels from the voxel to the spatial light modulator. However, the area of the holographic image reconstructed by the holographic display system may be limited depending on the performance of the spatial light modulator. Therefore, research is needed to expand the area of the reconstructed holographic image and improve the quality of the reconstructed holographic image in the holographic display technology which uses the spatial light modulator. In addition, when displaying the reconstructed holographic image by overlaying the holographic image with a real-world scene, such as the augmented reality display, an optical image combiner is additionally required to combine the virtual image with the real image, which complicates the optical system and has limitations in that optical loss occurs.

### Technical Problem

An object of the present disclosure is to reconstruct a holographic image by implementing an amplitude mask in a spatial light modulator.

Furthermore, according to one embodiment, an object of the present disclosure is to arrange apertures of the amplitude mask aperiodically.

Furthermore, according to one embodiment, an object of the present disclosure is to implement the amplitude mask in a reflective structure, thereby enabling the amplitude mask to function as an optical coupler in an augmented reality head-up display (HUD) or near-eye display (NED).

Objects of the present disclosure are not limited to the objects mentioned above, and other objects not mentioned will be clearly understood by those skilled in the art from the following description.

### Solution to Problem

According to the disclosure, an optical system for reconstructing a holographic image using an amplitude mask may include: a light source for emitting light, a spatial light modulator for controlling a phase or amplitude of the light, an amplitude mask for spatially controlling the amplitude of the light and diffracting the light to expand a range of output angles of the light and a reconstruction plane on which a holographic image reconstructed based on interference of the light is formed, wherein the amplitude mask includes a plurality of apertures arranged at arbitrary locations and wherein the plurality of apertures are formed as open holes or formed by mirrors that reflect or diffract the light.

According to the disclosure, a method for reconstructing a holographic image using an amplitude mask may include: controlling a phase or amplitude of light emitted from a light source using a spatial light modulator, spatially controlling the amplitude of the light using an amplitude mask to diffract the light and reconstructing a holographic image based on interference of the light, wherein the amplitude mask includes a plurality of apertures arranged at arbitrary locations and wherein the plurality of apertures are formed as open holes or formed by mirrors that reflect or diffract the light.

According to the disclosure, a computer-readable recording medium having instructions stored thereon that, when executed by a computer, may cause the computer to: control a phase or amplitude of light emitted from a light source using a spatial light modulator, spatially control the amplitude of the light using an amplitude mask to diffract the light and reconstruct a holographic image based on interference of the light, wherein the amplitude mask includes a plurality of apertures arranged at arbitrary locations and wherein the plurality of apertures are formed as open holes or formed by mirrors that reflect or diffract the light.

### Advantageous Effects

According to the present disclosure, it is possible to expand a reconstruction area of a holographic image and improve the resolution of the holographic image.

Furthermore, according to one embodiment, it is possible to narrow the depth of the holographic image and reduce speckle noise.

Furthermore, according to one embodiment, it is possible to maintain the consistency of a holographic image by evenly distributing a frequency component of light.

Furthermore, according to one embodiment, by implementing the amplitude mask as a reflective structure, a holographic image and an external image can be combined and provided in a transmissive augmented reality display device.

Effects obtained from the present disclosure are not limited to the effects mentioned above, and other effects not mentioned will be clearly understood by those skilled in the art from the description below.

### BRIEF DESCRIPTION OF THE DRAWINGS

FIG. 1 is a diagram illustrating a light propagation process based on a Fresnel transform according to one embodiment of the present disclosure.

FIG. 2 is a block diagram illustrating an optical system for reconstructing a holographic image according to one embodiment of the present disclosure.

FIG. 3 is a diagram illustrating an amplitude mask according to one embodiment of the present disclosure.

FIG. 4 is a flowchart illustrating a method for reconstructing the holographic image according to one embodiment of the present disclosure.

### DETAILED DESCRIPTION

Hereinafter, some embodiments of the disclosure will be described in detail with reference to illustrative drawings. It should be noted that, in adding reference numerals to the components in each drawing, the same reference numerals are used for the same components as much as possible, even if they are shown in different drawings. In addition, in describing the disclosure, when it is determined that a specific description of a related known configuration or function may obscure the gist of the disclosure, a detailed description thereof will be omitted.

In describing the components of the embodiments according to the disclosure, reference numerals such as first, second, i), ii), a), and b) may be used. These numerals are merely used to distinguish one component from another component, and do not limit the nature, order, sequence, or the like of the components by such numerals. In the specification, when a part is described as “comprising” or “including” a certain component, it means that other components may be further included instead of excluding other components unless explicitly stated to the contrary.

The following detailed description, together with the accompanying drawings, is intended to describe exemplary embodiments of the present disclosure, and is not intended to represent the only embodiments in which the present disclosure may be practiced.

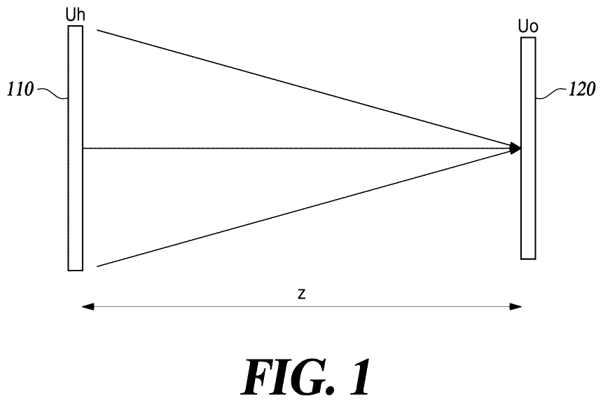

FIG. 1 is a diagram illustrating a light propagation process based on a Fresnel transform according to one embodiment of the present disclosure.

Referring to FIG. 1, the maximum angle at which light passing through a spatial light modulator 110 can be diffracted is limited by a pixel period of the spatial light modulator 110 according to a diffraction theorem. The diffraction angle of light is the angle at which light passing through the spatial light modulator 110 spreads. The pixel period of the spatial light modulator 110 is the distance from the center of one pixel of the spatial light modulator 110 to the center of the next pixel. The spatial frequency that the spatial light modulator 110 can express at its maximum is determined based on the pixel period of the spatial light modulator 110. That is, the spatial frequency that the spatial light modulator 110 can express to the maximum may be determined based on the Nyquist-Shannon sampling theorem so that the optical signal passing through the spatial light modulator 110 does not cause aliasing. The Nyquist-Shannon sampling theorem is a theory that the sampling frequency should be at least twice the maximum frequency of the input signal.

When a voxel reconstructed on a reconstruction plane 120 is located close to the spatial light modulator 110 or far from the center of the spatial light modulator 110, the display area of the hologram pattern of the spatial light modulator 110 that contributes to reconstructing the voxel can be limited and calculated. The voxel of the reconstruction plane 120 and the hologram pattern of the spatial light modulator 110 may be expressed as in Mathematical Expression 1 based on the Fresnel transform.

$${U}_{h} ( x , y ) = {e}^{j \frac{π}{λ z} ( {x}^{2} + {y}^{2} )} {U}_{o} ( ξ , η ) {e}^{j \frac{π}{λ z} ( {ξ}^{2} + {η}^{2} )} exp [ - j \frac{2 π}{λ z} ( ξ x + η y ) ] d ξ d η \qquad [ Mathematical Expression 1 ]$$

Uh is the hologram pattern of the spatial light modulator 110, Uo is the voxel of the reconstruction plane 120, (x,y) represent coordinates on the spatial light modulator 110, (tn) represent coordinates on the reconstruction plane 120, z is the distance between the spatial light modulator 110 and the reconstruction plane 120, and A is the wavelength of light.

The hologram pattern of the spatial light modulator 110 corresponding to the voxel has a different spatial frequency depending on the location of the voxel. The maximum spatial frequency of the spatial light modulator 110 is determined based on the size of the object reconstructed on the reconstruction plane 120 and the size of the hologram pattern displayed on the spatial light modulator 110. The minimum size of the voxel reconstructed on the reconstruction plane 120 is determined based on the size of the hologram pattern displayed on the spatial light modulator 110. The farther the location of the voxel is from the center of the spatial light modulator 110 or closer to the spatial light modulator 110, the smaller the effective hologram area required to reconstruct the corresponding voxel in the spatial light modulator 110. The effective hologram area is an area within the spatial light modulator 110 that contributes to the reconstruction of the voxel.

The limitation of the effective holographic area based on the voxel location affects the depth of field (DoF) of the reconstructed holographic image. The depth of a holographic image is the range of depths that are clearly visible in the reconstructed 3D image. When the effective holographic area is narrowed, the depth of the reconstructed holographic image increases. Consequently, an accommodation effect may be reduced. The accommodation effect is the user's eye response that adjusts focus according to depth. When the effective holographic area is narrowed, the resolution of the reconstructed holographic image may decrease, resulting in poor image quality. Therefore, it is necessary to expand the effective hologram area, narrow the depth of the reconstructed holographic image, and improve the resolution of the reconstructed holographic image. Below, a method for expanding the effective holographic area using the amplitude mask is described.

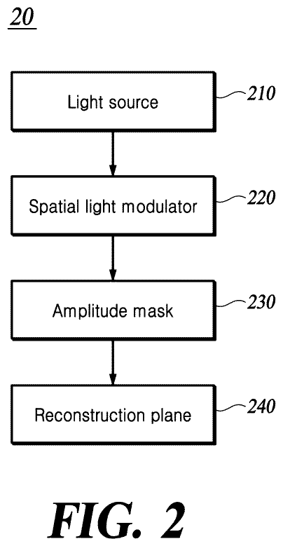

FIG. 2 is a block diagram illustrating an optical system for reconstructing the holographic image according to one embodiment of the present disclosure.

Referring to FIG. 2, the optical system for reconstructing the holographic image (hereinafter, referred to as optical system 20) includes all or part of a light source 210, a spatial light modulator 220, an amplitude mask 230, and a reconstruction plane 240. The light source 210 is an object that emits light and emits the light and causes the light to be incident on the spatial light modulator 220. The spatial light modulator 220 is a device that adjusts the phase or amplitude of light on a pixel basis, and thus adjusts the phase or amplitude of light incident from the light source 210. The spatial light modulator 220 adjusts the phase or amplitude of the light and causes the light to be incident on the amplitude mask 230.

The amplitude mask 230 is an optical element that spatially controls the amplitude of incident light and includes transparent and opaque portions. The transparent portion is an aperture that allows incident light to pass through and maintain the amplitude of the light, and the opaque portion blocks the light. The amplitude mask 230 may be implemented in a binary structure. The amplitude mask 230 may be arranged on the plane of the spatial light modulator 220 or may be arranged at a position spaced apart from the spatial light modulator 220 based on the optical axis. The amplitude mask 230 diffracts light incident from the spatial light modulator 220 to expand the range of the output angles of the light. The light passing through the amplitude mask 230 is propagated for a predetermined distance. This propagation of light may be implemented using a Fresnel diffraction model or a Fourier transform-based propagation model. Here, Fresnel's diffraction model mathematically describes the diffraction that occurs when light propagates over relatively short distances. The Fourier transform-based propagation model analyzes light in the frequency domain and uses the Fourier transform to calculate how light changes through space.

The amplitude mask 230 may be implemented as a reflective structure instead of a transmissive structure. In this case, the amplitude mask 230 may function as the optical image combiner. To this end, the transparent and opaque portions of the amplitude mask 230 may be reversed, and the existing aperture portions may be formed into pin-mirrors using a thin film coating, and the regions corresponding to the opaque portions may be formed as transmissive regions on a transparent substrate. This reflective structure may perform reflection and diffraction of light, selectively reflecting incident light and allowing real-world light to pass through the remaining portion, thereby functioning as an optical image combiner within an optical system.

The light propagating from the amplitude mask 230 reaches the reconstruction plane 240 and causes interference. The interference of light generated at the reconstruction plane 240 reconstructs the holographic image.

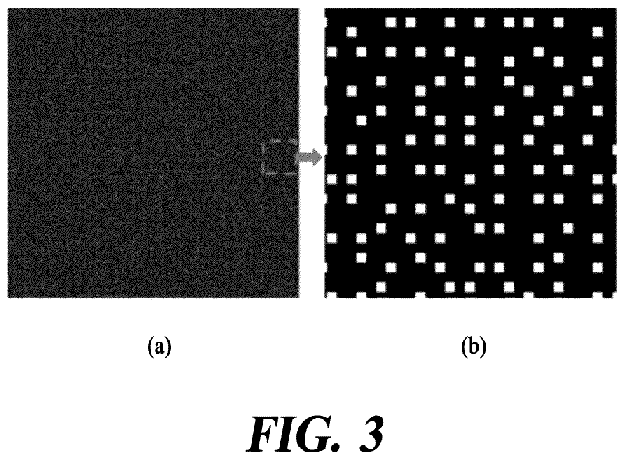

FIG. 3 is a diagram illustrating an amplitude mask according to one embodiment of the present disclosure.

Referring to FIG. 3, (a) is an image in which a random binary pattern is applied to transparent and opaque portions in the entire area of the amplitude mask 230, and (b) is an image in which a specific area of the amplitude mask 230 is enlarged to visually illustrate the arrangement of apertures, which are transparent portions. The distribution of the apertures of the amplitude mask 230 may be randomly distributed based on the Poisson disk sampling technique. Here, the Poisson disk sampling technique is a sampling technique in which points are distributed in space so that they are spaced apart by a certain minimum distance. Since the apertures of the amplitude mask 230 are arranged non-periodically, the frequency components of light passing through the amplitude mask 230 may be evenly distributed. The apertures of the amplitude mask 230 can be arranged so as not to overlap each other and to maintain a certain minimum distance from each other. The arrangement of the apertures of the amplitude mask 230 may be used to prevent unnecessary high-order diffraction. The high-order diffraction is when light is strongly diffracted in specific directions.

dij which is the distance between the apertures of the amplitude mask 230 is designed to satisfy the condition of Mathematical Expression 2 for dmin which is the minimum distance between the apertures.

$${d}_{ij} = \sqrt{{( {x}_{i} - {x}_{j} )}^{2} + {( {y}_{i} - {y}_{j} )}^{2}} \geq {d}_{min} \qquad [ Mathematical Expression 2 ]$$

Here, (xi, yi) may be the position of a specific aperture, and (xj, yj) may be the position of an aperture closest to the specific aperture. When the radius of each aperture is ri, the area of the aperture is πri2. The transmittance of the amplitude mask 230 is a value obtained by dividing the sum of the areas of the apertures of the amplitude mask 230 by the total area of the amplitude mask 230. Accordingly, the transmittance of the amplitude mask 230 may be determined by adjusting dmin, which is the minimum distance between the apertures of the amplitude mask 230, and ri, which is the radius of each aperture.

Each aperture of the amplitude mask 230 may be designed to have a size smaller than the size of a unit sample in the optical field plane on which the amplitude mask 230 is arranged. Here, the optical field plane may be a plane of the spatial light modulator 220, and the unit sample may be a pixel of the spatial light modulator 220. Accordingly, light incident on the amplitude mask 230 is diffracted, and the range of the output angles of the light may be expanded. When the range of the output angles of the light passing through the amplitude mask 230 is expanded, the effective hologram area may be expanded. That is, when the sizes of the apertures of the amplitude mask 230 are designed to be smaller than a predetermined size, the entire display area of the spatial light modulator 220 may be utilized as the effective hologram area. When the effective hologram area is expanded, more pixels of the spatial light modulator 220 contribute to the reconstruction of voxels, so the resolution of the reconstructed holographic image may be improved. Furthermore, as the effective hologram area expands, the depth of the reconstructed holographic image narrows, which can improve the accommodation effect experienced by the user. Furthermore, as the effective holographic area expands, the size of speckle grains can be reduced. The speckle is formed by the interference of light arriving along various paths.

When the range of the output angles of light passing through the amplitude mask 230 is expanded, a holographic pattern exceeding the range of the maximum spatial frequency of the spatial light modulator 220 may also be expressed. Accordingly, the range of voxels that can be reconstructed in the three-dimensional space of the reconstruction plane 240 may be expanded. When the range of the output angles of light passing through the amplitude mask 230 is expanded, the reconstructed holographic image may have a uniform light intensity distribution.

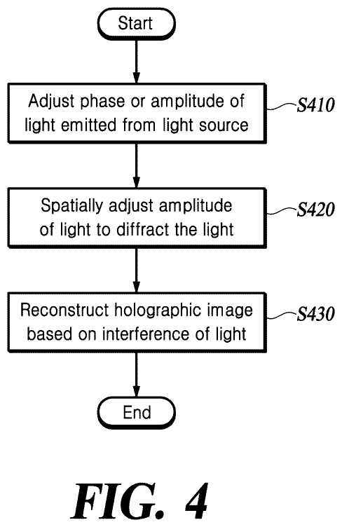

FIG. 4 is a flowchart illustrating a method for reconstructing the holographic image according to one embodiment of the present disclosure.

Referring to FIG. 4, the spatial light modulator 220 adjusts the phase or amplitude of light emitted from the light source 210 (S410). The amplitude mask 230 spatially adjusts the amplitude of light to diffract the light (S420). The optical system 20 reconstructs the holographic image based on the interference of light (S430). The amplitude mask 230 may include the plurality of apertures arranged at arbitrary positions. The amplitude mask 230 may include the plurality of apertures arranged spaced apart from each other by a predetermined minimum interval or more. The amplitude mask 230 may have a transmittance defined based on the ratio of the area of the plurality of apertures to the area of the amplitude mask. The transmittance may be determined based on the radius of the plurality of apertures and the predetermined minimum interval. The amplitude mask 230 may be arranged on the plane of the spatial light modulator 220 or may be arranged at a position spaced apart from the spatial light modulator 220 based on the axis of light. The amplitude mask 230 may include the plurality of apertures having a size smaller than the pixels of the spatial light modulator 220. The amplitude mask 230 may be a binary mask including the plurality of apertures that are transparent portions and opaque portions. The amplitude mask 230 may include a plurality of apertures arranged at arbitrary positions based on the Poisson disk sampling technique.

In addition, the amplitude mask 230 may be formed as a reflective structure in which the plurality of apertures are formed as a reflective diffractive structure, and the remaining portion is formed as a transparent substrate. In such a reflective amplitude mask, the aperture portion of a conventional transmissive amplitude mask structure may be replaced with a reflective structure. Accordingly, the reflective amplitude mask may selectively reflect incident light, and the remaining area may transmit real-world light, thereby functioning as the optical image combiner.

Each element of the apparatus or method in accordance with the present invention may be implemented in hardware or software, or a combination of hardware and software. The functions of the respective elements may be implemented in software, and a microprocessor may be implemented to execute the software functions corresponding to the respective elements.

Various embodiments of systems and techniques described herein can be realized with digital electronic circuits, integrated circuits, field programmable gate arrays (FPGAs), application specific integrated circuits (ASICs), computer hardware, firmware, software, and/or combinations thereof. The various embodiments can include implementation with one or more computer programs that are executable on a programmable system. The programmable system includes at least one programmable processor, which may be a special purpose processor or a general purpose processor, coupled to receive and transmit data and instructions from and to a storage system, at least one input device, and at least one output device. Computer programs (also known as programs, software, software applications, or code) include instructions for a programmable processor and are stored in a “computer-readable recording medium.”

The computer-readable recording medium may include all types of storage devices on which computer-readable data can be stored. The computer-readable recording medium may be a non-volatile or non-transitory medium such as a read-only memory (ROM), a random access memory (RAM), a compact disc ROM (CD-ROM), magnetic tape, a floppy disk, or an optical data storage device. In addition, the computer-readable recording medium may further include a transitory medium such as a data transmission medium. Furthermore, the computer-readable recording medium may be distributed over computer systems connected through a network, and computer-readable program code can be stored and executed in a distributive manner.

Although operations are illustrated in the flowcharts/timing charts in this specification as being sequentially performed, this is merely an exemplary description of the technical idea of one embodiment of the present disclosure. In other words, those skilled in the art to which one embodiment of the present disclosure belongs may appreciate that various modifications and changes can be made without departing from essential features of an embodiment of the present disclosure, that is, the sequence illustrated in the flowcharts/timing charts can be changed and one or more operations of the operations can be performed in parallel.

Thus, flowcharts/timing charts are not limited to the temporal order.

Although exemplary embodiments of the present disclosure have been described for illustrative purposes, those skilled in the art will appreciate that various modifications, additions, and substitutions are possible, without departing from the idea and scope of the claimed invention. Therefore, exemplary embodiments of the present disclosure have been described for the sake of brevity and clarity. The scope of the technical idea of the present embodiments is not limited by the illustrations. Accordingly, one of ordinary skill would understand that the scope of the claimed invention is not to be limited by the above explicitly described embodiments but by the claims and equivalents thereof.

What is claimed is:

1. An optical system comprising:
a light source for emitting light;
a spatial light modulator for controlling a phase or amplitude of the light;
an amplitude mask for spatially controlling the amplitude of the light and diffracting the light to expand a range of output angles of the light; and
a reconstruction plane on which a holographic image reconstructed based on interference of the light is formed,
wherein the amplitude mask includes a plurality of apertures arranged at arbitrary locations, and
wherein the plurality of apertures are formed as open holes or formed by mirrors that reflect or diffract the light.

2. The optical system of claim 1, wherein the amplitude mask includes a plurality of apertures spaced apart from each other by at least a predetermined minimum interval.

3. The optical system of claim 2, wherein the amplitude mask has a transmittance defined based on a ratio of a total area of the plurality of apertures to an area of the amplitude mask.

4. The optical system of claim 3, wherein the transmittance is determined based on a radius of the plurality of apertures and the predetermined minimum interval.

5. The optical system of claim 1, wherein the amplitude mask is arranged on a plane of the spatial light modulator.

6. The optical system of claim 1, wherein the amplitude mask is arranged at a position spaced apart from the spatial light modulator based on an optical axis.

7. The optical system of claim 1, wherein the amplitude mask includes the plurality of apertures having a size smaller than a pixel of the spatial light modulator.

8. The optical system of claim 1, wherein the amplitude mask uniformly distributes spatial frequency components of the light using a plurality of apertures arranged at arbitrary locations.

9. The optical system of claim 1, wherein the amplitude mask is a binary mask including the plurality of apertures, which are transparent portions, and opaque portions.

10. The optical system of claim 1, wherein the amplitude mask includes the plurality of apertures arranged at arbitrary locations based on a Poisson disk sampling technique.

11. A method performed by an optical system, the method comprising:
controlling a phase or amplitude of light emitted from a light source using a spatial light modulator;
spatially controlling the amplitude of the light using an amplitude mask to diffract the light; and
reconstructing a holographic image based on interference of the light,
wherein the amplitude mask includes a plurality of apertures arranged at arbitrary locations, and
wherein the plurality of apertures are formed as open holes or formed by mirrors that reflect or diffract the light.

12. The method of claim 11, wherein the amplitude mask includes a plurality of apertures spaced apart from each other by a predetermined minimum interval or more.

13. The method of claim 12, wherein the amplitude mask has a transmittance defined based on a ratio of an area of the plurality of apertures to an area of the amplitude mask.

14. The method of claim 13, wherein the transmittance is determined based on a radius of the plurality of apertures and the predetermined minimum interval.

15. The method of claim 11, wherein the amplitude mask is arranged on a plane of the spatial light modulator.

16. The method of claim 11, wherein the amplitude mask is arranged at a position spaced apart from the spatial light modulator based on an optical axis.

17. The method of claim 11, wherein the amplitude mask includes the plurality of apertures having a size smaller than a pixel of the spatial light modulator.

18. The method of claim 11, wherein the amplitude mask is a binary mask including the plurality of apertures, which are transparent portions, and opaque portions.

19. The method of claim 11, wherein the amplitude mask includes the plurality of apertures arranged at arbitrary locations based on a Poisson disk sampling technique.

20. A computer-readable, non-transitory recording medium having stored thereon instructions, which, when executed by the computer, cause the computer to:
control a phase or amplitude of light emitted from a light source using a spatial light modulator;
spatially control the amplitude of the light using an amplitude mask to diffract the light; and
reconstruct a holographic image based on interference of the light,
wherein the amplitude mask includes a plurality of apertures arranged at arbitrary locations, and
wherein the plurality of apertures are formed as open holes or formed by mirrors that reflect or diffract the light.
